(19) United States
(12) Patent Application Publication
(10) Pub. No.: US 2016/0016383 A1
(43) Pub. Date: Jan. 21, 2016

(54) THE PRESENT INVENTION RELATES TO AN IMPROVED GIFT WRAP

(71) Applicant: GWM DESIGNS LIMITED, Coventry (GB)

(72) Inventor: Gail Wendy Muirhead, Reading, Berkshire (GB)

(21) Appl. No.: 14/765,743

(22) PCT Filed: Feb. 4, 2014
(86) PCT No.: PCT/GB2014/000040

§ 371 Date: Aug. 4, 2015

(30) Foreign Application Priority Data
Feb. 5, 2013 (GB) 1302044.1

(51) Int. Cl. B32B 7/04; B32B 15/20; B32B 27/12; B32B 15/14

(52) U.S. Cl. CPC B32B 7/045; B32B 15/14; B32B 15/20; B32B 27/12; B32B 2307/306; B32B 2307/412; B32B 2307/7265; B32B 2451/00; B32B 2553/00

(57) ABSTRACT

A gift wrap (10) comprises at least one flexible textile layer (14, 16), and at least one plastically deformable layer (12), a surface of the plastically deformable layer (12) being bonded to a surface of the flexible textile layer (14, 16).

### BACKGROUND TO THE INVENTION

Gift wrap is commonly used for wrapping gifts. It provides the gift with an attractive outward appearance, which may include for example bright colours, geometric patterns, or messages of good wishes to the recipient. Furthermore, enclosing a present in wrapping paper disguises the contents of the package, so that the receiver of the gift may be surprised when the present is opened.

Conventional gift wrap is usually made substantially from paper, though other materials may be included, for example where a shiny metallic effect is desired. However, paper tears easily, and great care must therefore be taken when wrapping a present, particularly if the gift to be wrapped is an irregular shape or includes sharp corners.

To wrap a gift, it is typically placed upon a portion of wrapping paper, at a point substantially equidistant between two sides of the portion of paper. The two opposing sides of the wrapping paper are then folded around and over the gift, meeting and slightly overlapping on top of the item being wrapped. At this stage, the wrapping paper must be held in place whilst a fixing means is procured, possibly cut to an appropriate length or otherwise suitably prepared, and finally applied to join together the two sides of wrapping paper. It is easy for the wrapping paper to move out of position during this operation, potentially resulting in a present which is inadequately wrapped. Wrapping presents neatly is especially difficult for children and those with poor manual dexterity.

If a mistake is made whilst wrapping, then the fixing means (for example, sticky tape) may be removed, and the positioning of the paper corrected before re-fixing. However, the paper may be irreversibly creased in the wrong place, and removal of sticky tape is likely to damage the decorative surface of the wrapping paper, resulting in a substandard present. For the same reason, wrapping paper which is used to wrap one present and then re-used for a second present does not provide such an attractive covering the second time.

Wrapping paper is typically thin and comes on rolls. It is therefore difficult to fold conventional paper into complex decorative shapes. Even if folded decorations are made from conventional paper, they may easily be damaged.

Wrapping paper is not generally water resistant. Once paper becomes soggy it will tear very easily. Even if dried out, the surface of the paper may be warped. Wrapping paper is sometimes used for covering the surfaces of flower pots, for example underneath a Christmas tree. In such circumstances, lack of water resistance is a problem.

It is an object of the invention to reduce or substantially obviate the above mentioned problems.

### STATEMENT OF INVENTION

According to the present invention, a gift wrap comprises at least one flexible textile layer, and at least one plastically deformable layer, a surface of the plastically deformable layer being bonded to a surface of the flexible textile layer.

When the gift wrap is folded, it remains in a folded position due to the plastically deformable layer. This enables a gift to be wrapped neatly, even by children or those with limited manual dexterity. Sticky tape or other fixing means are not required to hold the wrapping together, since the gift wrap remains in position, holding the gift inside. Additionally, the gift wrap is tear resistant and reusable. When used to wrap a gift, the flexible textile layer will typically be disposed on the outside, providing the outer surface of the gift with an attractive look and feel.

A second flexible textile layer may be bonded to the other surface of the plastically deformable layer. The wrapping paper may therefore be used with either side facing outwards. A different texture or pattern may be provided on the second flexible textile layer than on the first textile layer, enabling the present wrapper to choose between two designs without the need for several different gift wraps.

The plastically deformable layer may be a metallic sheet or foil. A thin metal sheet is plastically deformable and water resistant, but can be cut easily with scissors.

The plastically deformable layer may be bonded to the flexible textile layer across the entire surface of the plastically deformable layer. The two layers are thus completely held together, and the flexible textile layer will bend with the plastically deformable layer.

Alternatively, the plastically deformable layer may be bonded to the flexible textile layer at only parts of the surface of the plastically deformable layer. For example, the layers may be joined by spaced-apart spots of adhesive, or by a square grid of adhesive having non-adhesive sections within the squares. Bonding the layers together only in sections allows the flexible textile layer to more easily stretch around the outside of bends in the plastically deformable layer.

All of the constituent layers of the gift wrap, as well as the bonding means between layers, may be heat resistant. A heat resistant gift wrap is advantageous because it allows the gift wrap to be ironed, removing creases from the textile layers and restoring used gift wrap to an as-new condition.

A water resistant layer may be included, a surface of the water resistant layer being bonded to a surface of the flexible textile layer. The water resistant layer may be made from plastics and may be transparent, therefore protecting the flexible textile layer from moisture, whilst not impacting upon the visual effect of the gift wrap.

### DESCRIPTION OF THE DRAWINGS

For a better understanding of the present invention, and to show more clearly how it may be carried into effect, reference will now be made by way of example only to the accompanying drawings, in which:

FIG. 1 shows a cross-section through a gift wrap according to the present invention;

FIG. 2 shows a gift in the process of being wrapped with the gift wrap of FIG. 1;

FIG. 3 shows a gift wrapped with the gift wrap of FIG. 1; and

FIG. 4 shows a decoration made from the gift wrap of FIG. 1.

### DESCRIPTION OF PREFERRED EMBODIMENT

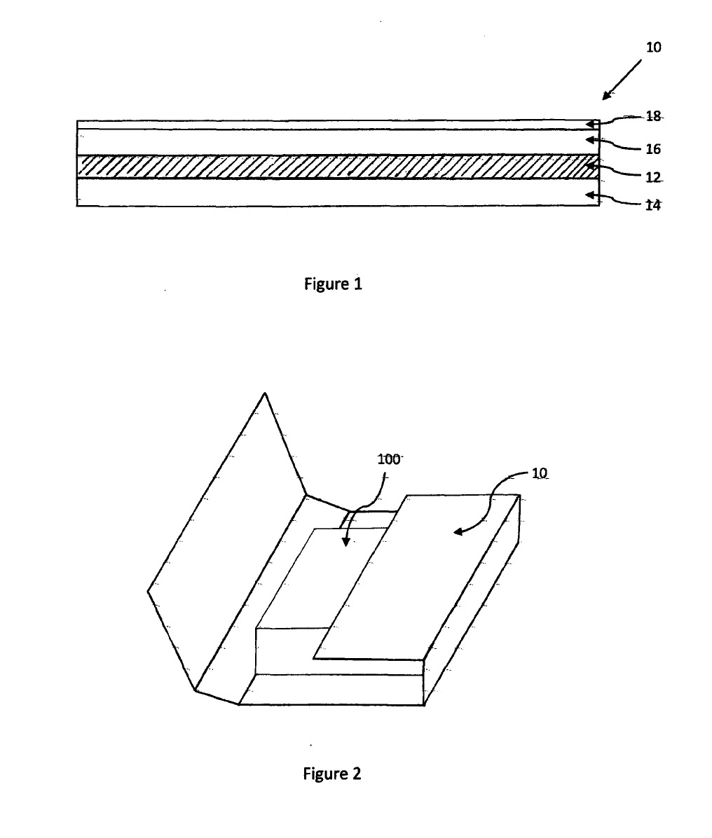

Referring firstly to FIG. 1, a gift wrap is indicated generally at 10. The gift wrap includes a metallic layer 12, a first textile layer 14, a second textile layer 16, and a water resistant layer 18. All of the layers extend across the whole area of the gift wrap.

The first and second textile layers 14, 16 are bonded to either side of the metallic layer 12. That is, the metallic layer 12 is sandwiched between the two textile layers 12, 14. The textile layers may be bonded to the metallic layer across the entire surface area of the layers, or alternatively areas of adhesive may be spaced apart by areas in which the layers are not bonded together. The pattern of adhesive may be disjoint, for example spaced-apart areas of adhesive, or may be continuous, for example a grid of adhesive with non-adhesive squares within the grid.

The first and second textile layers 14, 16, the metallic layer 12 and the adhesive bonding the layers together is heat resistant. This allows the gift wrap to be ironed to remove creases from the textile layers 14, 16, as explained below.

The metallic layer 12 is plastically deformable, so that when it is folded it remains in its folded position until it is positively unfolded. For example, the metallic layers can be a foil, such as aluminium foil. The textile layers are flexible, and can be ironed to remove creasing. This enables the gift wrap to be opened out after use, and ironed flat for re-use. The gift wrap can also be pressed flat by hand, the plastically deformable layer assisting with this. In use, it is the textile layers on the outside which are seen. The textile layers are made from a fabric having an attractive texture, for example silk. Patterns and/or colours and other surface decorations may be applied to the textile layers.

Water resistant layer 18 is made from plastics, and is transparent. The water resistant layer is bonded to the surface of textile layer 16 which is not bonded to the metallic layer 12. The water resistant layer protects the textile layer from damage due to moisture and dirt, and allows the surface of the gift wrap to be wiped clean. In this embodiment, the water resistant layer is provided on only one side of the gift wrap 10, but it is envisaged that water resistant layers might alternatively be provided on both sides.

As seen in FIG. 2, the gift wrap 10 may be folded around a gift 100. As the gift wrap is folded, it retains its folded shape around the gift. The gift can therefore be wrapped without any sticky tape or other fixing means, and the wrapping can be achieved with one hand if necessary.

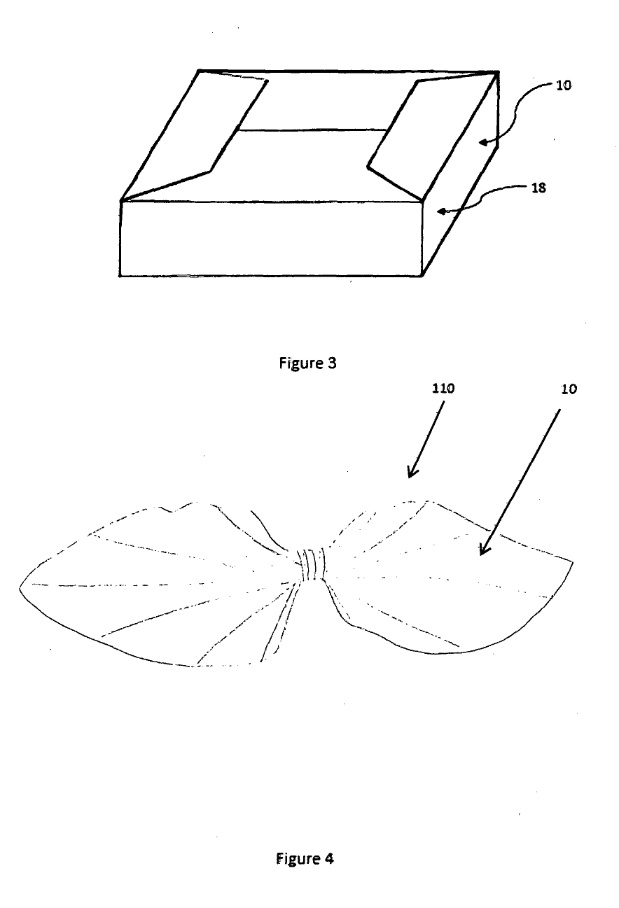

FIG. 3 shows the gift 100 enclosed by gift wrap 10. No sticky tape or similar fastening means has been used, which ensures that the entire outer surface of the gift is of the attractive texture of the textile layers 14, 16. The gift is protected from moisture by water resistant layer 18. If required, a ribbon or similar may be tied around the gift.

FIG. 4 shows a decorative novelty bow 110 folded from gift wrap 10. The gift wrap 10 is ideal for folding into complex decorative shapes, the resulting decorations being tear resistant and attractive.

It will be appreciated that the second textile layer 16 and water resistant layer(s) are optional, and the gift wrap can be provided with a single textile layer, a textile layer on either side, or with a water-resistant textile on one or both sides.

Gift wrap 10 is strong, and does not tear easily. When folded, it retains its shape, and does not require tape or other fixing means. The gift wrap is re-usable, as any creases in the textile layers may be removed by ironing, and is water resistant, protecting both the gift wrap and the gift from moisture. The gift wrap is attractive to look at and to feel.

1. A gift wrap comprising at least one flexible textile layer, and at least one plastically deformable layer, a surface of the plastically deformable layer being bonded to a surface of the flexible textile layer.

2. A gift wrap as claimed in claim 1, in which a second flexible textile layer is bonded to the other surface of the plastically deformable layer.

3. A gift wrap as claimed in claim 1 or claim 2, in which the plastically deformable layer is a metallic sheet.

4. A gift wrap as claimed in claim 3, in which the plastically deformable layer is aluminium foil.

5. A gift wrap as claimed in any of the preceding claims, in which the plastically deformable layer is bonded to the flexible textile layer across and entire surface of the plastically deformable layer.

6. A gift wrap as claimed in any of claims 1 to 4, in which the plastically deformable layer is bonded to the flexible textile layer at only parts of the surface of the plastically deformable layer.

7. A gift wrap as claimed in any of the preceding claims, in which all of the constituent layers and the bonding means are heat resistant.

8. A gift wrap as claimed in any of the preceding claims, in which at least one water resistant layer is included, a surface of the water resistant layer being bonded to a surface of the flexible textile layer.

9. A gift wrap as claimed in claim 8, in which the water resistant layer is made from plastics.

10. A gift wrap as claimed in claim 8 or claim 9, in which the water resistant layer is transparent.

11. A wrapping material substantially as described herein, with reference to and as illustrated in FIGS. 1 to 4 of the accompanying drawings.
